(19) United States
(12) Patent Application Publication
(10) Pub. No.: US 2008/0129583 A1
(43) Pub. Date: Jun. 5, 2008

(54) Radar level detector

(76) Inventors: Lars Ove Larsson, Linkoping (SE); Mats Nordlund, Molndal (SE); Fabian Wenger, Goteborg (SE); Valter Nilsson, Hovas (SE)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/607,291

(22) Filed: Dec. 1, 2006

(51) Int. Cl. G01S 13/08

(52) U.S. Cl. 342/124

(57) ABSTRACT

A radar level detector for detecting that a surface of a product in a tank has entered a predefined distance range in an upper half of said tank, said level detector comprising a transmitter for transmitting an electromagnetic transmission signal into the tank, a propagation device for allowing said transmission signal to propagate towards said surface and for returning a reflection of said transmission signal from said surface, a selector for selecting a portion of said reflection, said portion defining said predefined distance range, a detector for setting a discrete signal to an active level if said portion includes information indicating a surface reflection, and an interface for communicating said discrete signal externally of said level detector.

As it is not necessary to determine the filling level at every point in time, the signal processing of the detector according to the present invention can be significantly simplified, leading to a more cost efficient product and less power consumption.

### FIELD OF THE INVENTION

The present invention relates to a radar level detector based on transmission of electromagnetic waves that are allowed to propagate into a tank and reception of a reflection of these waves. More specifically, the invention relates to a radar level detector that is adapted to detect when the filling level of a product in the tank reaches a predefined level.

### BACKGROUND ART

In some situations it may be required to measure the filling level of product in a tank at a given moment. Such measurement is often referred to as level gauging, and a widely spread technique to provide contact-free level gauging is based on transmission of electromagnetic waves into the tank, and reception of reflected waves. The relation between transmitted and received waves can be processed to obtain a distance to the reflecting surface, typically an interface between the product and an ambient atmosphere, e.g. air. Such radar level gauging is well known for its high precision, and is used in a wide field of applications, including marine applications, various process industries, as well as agricultural applications. The technique can advantageously be used not only to determine the level of a liquid product, but also solid products, such as pellets or grain.

Another category of level detection relates to the determination of whether or not the product level in the tank has reached a predetermined filling level. Such level detection may be used for process control (e.g. batch processing) and safety functions (e.g. overfill alarms). A typical overfill level alarm is adapted to generate an alarm when the filling level of the tank reaches a predefined level, e.g. 95% or 98% of the tank capacity. Conventionally, such level detection has been provided by a level switch operating in contact with the product.

One simple solution is to use a float, connected to some kind of electrical switch. When the float is lifted by the rising surface, electrical contact is made, and a signal is generated.

Another solution is a vibrating tuning fork detector, i.e. a piezo crystals that detects the frequency of another crystal and communicates with a processing circuitry. If the tuning fork is covered by liquid, the detected frequency changes, and this change can be detected by the processing circuitry to generate a switch signal.

Yet another solution is a microwave level switch that is adapted to detect when the microwave emitter is covered by the medium. An example of such a switch is the model LNM switch available from Kobold Messring GmbH.

Common for these prior art solutions is that they require physical contact of the product in the tank with the switch. This leads to problems related to the required interaction between the product in the tank and the switch (density required to lift float, adhesion of product to float reducing its mobility, required viscosity to influence frequency of the fork, material compatibility, etc).

A further problem lies in the fact that a switch relying on physical contact with the product must be physically installed in a fixed location. Not only is this an expensive and complicated process, but it also makes it very difficult to change the level at which the switch is activated. More specifically, it is impossibly to change the detected level dynamically without physically moving the switch, which in turn may require removing the contents of the tank.

Recently, attempts have been made to use the principles developed in the field of radar level gauging to provide a contact-free level detection, overcoming the above mentioned problems.

According to one solution (e.g. the Tank Radar® Rex sold by the applicant), this has been accomplished by providing a radar level gauge with an additional output signal, indicating whether a predefined level has been reached. The detection is based on comparing a detected level with a predetermined threshold, and generating the output signal based on this comparison, and thus requires software and hardware for a full range level detection. While this can be an effective solution in a case where radar level gauging is already required, it is a relatively expensive solution compared to a float or a fork level switch.

According to further solution (the Tank Radar® StaR sold by the applicant), a radar level gauge for marine applicatins is provided with additional software, specifically adapted to process a specific portion of the measurement signal, in order to establish if a surface reflection is present in a particular region. This information is provided to the level detection process to ensure a reliable result, e.g. to contribute to distinguishing the actual surface echo from disturbing echoes. The detected filling level is then made available to processing logic external of the gauge, in order to allow for a determination of whether the detected level exceed a predetermined threshold. Again, this is a complex and thus expensive solution, as it requires a full range level detection.

### OBJECT OF THE INVENTION

Therefore, an object of the present invention is to provide an inexpensive and simplified contact-free level detector based on transmission and reception of electromagnetic waves.

### GENERAL DISCLOSURE OF THE INVENTION

This object is achieved by a contact-free radar level detector and a contact-free radar level detection method for detecting that a surface of a product in a tank has entered a predefined distance range according to the appended claims.

A first aspect of the invention relates to a radar level detector for detecting that a surface of a product in a tank has entered a predefined distance range in an upper half of said tank, the level detector comprising a transmitter for transmitting an electromagnetic transmission signal into the tank, a propagation device for allowing the transmission signal to propagate towards the surface and for returning a reflection of the transmission signal from the surface, a selector for selecting a portion of the reflection, the portion defining the predefined distance range, a detector for setting a discrete signal to an active level if the portion includes information indicating a surface reflection, and an interface for communicating the discrete signal externally of the level detector.

A second aspect of the invention relates to a radar level detector for detecting that a surface of a product in a tank has entered a predefined distance range in an upper half of said tank, comprising a transmitter for transmitting an electromagnetic transmission signal into the tank, a propagation device for allowing the transmission signal to propagate towards the surface and for returning a reflection of the transmission signal from the surface, a detector for detecting if a reflection of the transmission signal occurs within the predefined distance range, without continuously establishing a filling level of the tank, and an interface for communicating a discrete output externally of the level detector, the discrete output indicating a result of the detection.

Electromagnetic waves is intended to include various types of electromagnetic radiation, such as, but not limited to, microwaves or laser.

The expression “entered” is intended to include a situation where the filling level increases to reach the predefined distance range as well as a situation where the tank level decreases to reach the predefined distance range.

The predefined distance range should be understood to correspond to only a limited region of the entire tank, typically a region in the top or bottom of the tank. Preferably, the region is an extreme region of the tank, i.e. the region immediately below the tank ceiling, or the region immediately above the tank bottom. As an example, the region can be the top 10% or 5% of the tank, thus providing a detection signal when the surface enters a distance range greater than 90% or 95% of the tank.

According to the invention, the output from the level detector is thus determined by whether a selected portion of the reflection includes information indicating a surface reflection. This is entirely different to the prior art, where a discrete output signal was based on determining a filling level and comparing it with a threshold.

As mentioned, the STaR gauge has an additional software module making a range selection and determining if an echo is present in this selected range. However, the indication obtained from this module is used only as a guiding input to the conventional, full range level detection, which determines a level output by conventional processing and communicates it externally of the gauge. Additional processing logic is required to collect this value and generate an alarm, e.g. by comparing it with a threshold.

It is therefore characterizing for the present invention that the selected range itself will define the predefined distance range that triggers the discrete signal. This is contrary to the STAR gauge process, where the selected range is completely independent from an alarm limit defined by a volume threshold.

As it is not necessary to determine the filling level at every point in time, the signal processing of the detector according to the present invention can be significantly simplified, leading to a more cost efficient product and less power consumption.

An additional factor contributing to cost efficiency is that the resolution of the level detector does not need to be as high as in a conventional radar level gauge.

In the case of a system based on pulse transmission, the pulses can therefore be longer, reducing requirements on bandwidth and simplifying the transmitter hardware. In the case of FMCW, the frequency sweep can be more narrow, making a number of ISM bands (that typically are too narrow for a conventional FMCW RLG) available for use. The simplification in terms of required bandwidth makes it possible to use a wide variety of inexpensive and rudimentary radio transmitters, such as Bluetooth circuits, monolithic radio transceivers, etc.

The level detector can include an input device for receiving a signal adapted to adjust the selected portion. Such an input device allows for simple adjustment of the predefined range, and thus the filling level that will trigger the discrete output.

The portion selected from the reflection can be a time window or a frequency band, depending on the modulation of the transmission signal, and the processing chosen to make the detection.

According to one embodiment, the detector comprises a mixer for generating a measurement signal by combining (e.g. multiplying) said reflected signal with said transmission signal, the measurement signal comprising information indicating a surface reflection. The selector is then adapted to select a portion of this measurement signal.

The mixer can be a frequency mixer such as used to mix frequency modulated signals, or a sample and hold circuit as used to combine dc-modulated pulses.

In the case of time domain measurement signal, such as generated by a pulsed radar level gauge, only a limited time window of the measurement signal, corresponding to the predefined distance range, needs to be processed. In a practical implementation this means that only this time window needs to be digitized and provided to a digital processor.

In one embodiment, the selected range can be only one sample. The sample is associated with a specific level, and the amplitude of this sample indicates whether or not there is a reflection at this level.

In the case of a frequency domain measurement signal, such as generated by a FMCW radar level gauge, only a limited frequency range of the measurement signal, corresponding to the predefined distance range, needs to be processed. This frequency range selection can be implemented as an analogue filter, e.g. a band pass filter, resulting in a selected frequency range. This range can then be analyzed to determine if it includes a surface echo. If the processing is digital, only this selected range needs to be sampled. Alternatively, the filter itself is implemented in software, in which case the entire measurement signal must be sampled before filtering.

### BRIEF DESCRIPTION OF THE DRAWINGS

These and other aspects of the present invention will now be described in more detail with reference to the appended drawings, illustrating currently preferred embodiments.

FIG. 1 is a perspective view of a radar level detector according to an embodiment of the present invention.

FIG. 2 is a schematic block diagram of the radar level detector in FIG. 1.

FIG. 3 is a schematic block diagram of a radar level detector according to a second embodiment of the present invention.

FIG. 4 is a schematic block diagram of a radar level detector according to a third embodiment of the present invention.

FIG. 5 is a schematic block diagram of a radar level detector according to a fourth embodiment of the present invention.

FIG. 6 is a time diagram of signals occurring in the detector in FIG. 4.

FIG. 7 is a schematic block diagram of a radar level detector according to a fifth embodiment of the present invention.

FIGS. 8a and 8b are time diagrams of a level detection using a staggered transmission pulse.

FIG. 9 is a flow chart illustrating a detection method according to an embodiment of the invention.

### DETAILED DESCRIPTION OF PREFERRED EMBODIMENTS

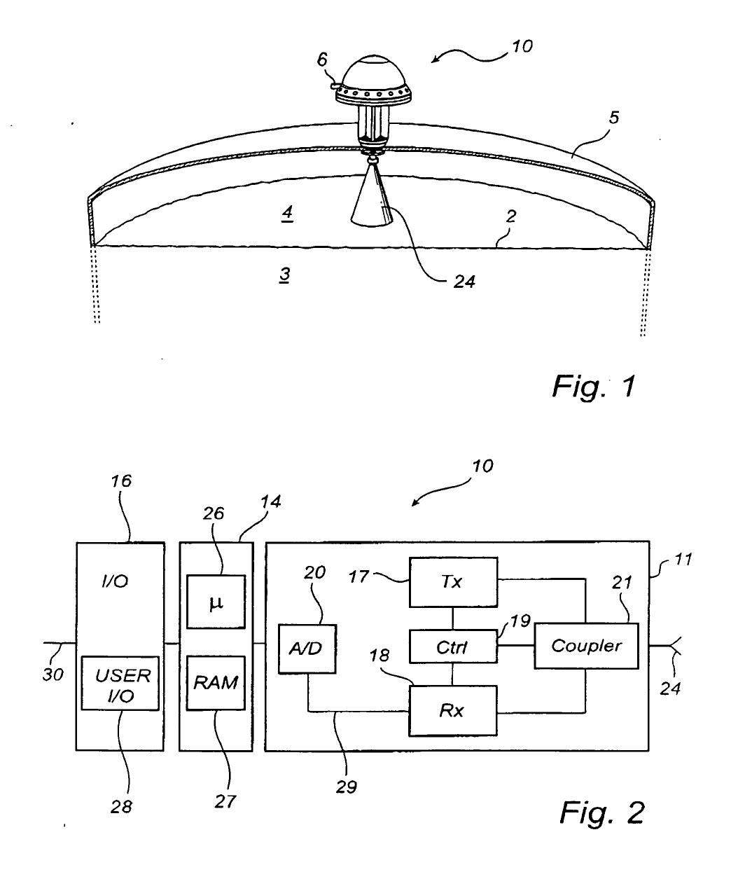

FIG. 1 shows a perspective view a radar level detector 10, in which the present invention can be implemented. The detector 10 is arranged to detect if an interface 2 between two (or more) materials 3, 4 in the tank 5, has entered a predefined distance range. Typically, the first material 3 is a content stored in the tank, e.g. a liquid such as gasoline, while the second material 4 is air or some other atmosphere. In that case, the detector will enable detection of the level of the surface of the content in the tank. Note that different tank contents have different impedance, and that the electromagnetic waves will only propagate through some materials in the tank. Typically, therefore, only the level of a first liquid surface is detected, or a second liquid surface if the first liquid is sufficiently transparent.

The detector 10 is provided with an output terminal 6 for communicating a discrete signal 30, indicating if the interface 2 has entered the predefined distance range, externally of the detector. The terminal 6 can be connected to suitable equipment, such as alarm handling equipment, if the detector is used as a level alarm, or processing control equipment, in case the detector is used as a batch control detector.

FIG. 2 is a schematic block diagram of the circuitry of the detector in FIG. 1. The detector 10 comprises transceiver circuitry 11, a propagation device 12, and a signal transfer medium 13 connecting the propagation device 12 to the transceiver circuitry 11. The detector 10 further comprises processing circuitry 14 connected to the transceiver circuitry 11, and an interface 16 for communication externally of the detector.

The transceiver circuitry 11 comprise a transmitter 17, a receiver 18, and control circuitry 19 required to manage these components. Further, the transceiver circuitry 11 comprises an A/D-converter 20.

The propagation device 12 can include two free radiating antennas (one emitting antenna and one receiving antenna), or, as illustrated in FIG. 1, include only one antenna 24. In this case, the transceiver circuitry 11 further comprises a directional coupler 21 allowing the one antenna to act both as emitter and receiver. Alternatively, the propagation device 12 can include a still pipe acting as a wave guide, or a transmission probe (e.g. coaxial probe, single probe, or twin probe) extending into the tank.

The signal transfer medium 13 can be a wire or cable, but can also include more sophisticated wave guides. In case of an explosive or otherwise dangerous content in the tank 5, the signal transfer medium 13 may include an air tight seal passing through the tank wall. It is also possible that the controller 11 is connected directly to the propagation device 12 with a suitable terminal, or that the propagation device 12 is arranged on the same circuit board as the controller 11, in which case the signal transfer medium simply may be a track on the circuit board.

The transceiver circuitry 11 is adapted to generate a signal in accordance with control data from the processing circuitry 14, and the processing circuitry 14 is adapted to determine a measurement result based on a relation between transmitted and received signals. The processing circuitry 14 can be implemented in designated circuits, but may also be implemented using a general purpose processor 26 controlled by software stored in a memory 27. The memory 27 may also be used for storing various control and calibration parameters.

The interface 16 is arranged to communicate a measurement result from the circuitry 14. In a very simple case, the interface 16 is a signal output terminal 6 (see FIG. 1), adapted to provide a discrete signal externally of the RLG 10. However, the interface 16 can also include a user interface 28, allowing a user to interface with the processing circuitry 14. In some applications, the interface 16 can also be arranged to provide power to the detector 10, for example via a 4-20 mA industrial loop.

Alternatively, the interface 16 is wireless, and comprises e.g. bluetooth circuitry or WLAN circuitry. In such case, the detector may be powered by an internal power supply, such as a battery.

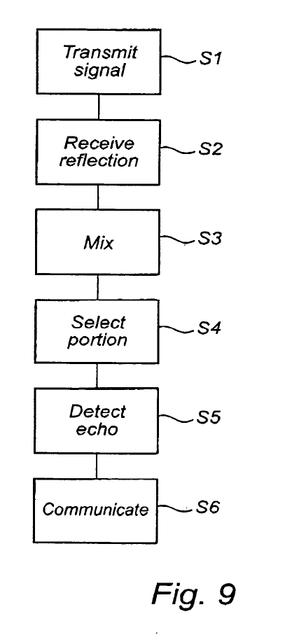

With reference to FIG. 9, the function of the detector in FIG. 1 will now be described. First, in step S1, the processing circuitry 14 controls the transmitter 17 in the transceiver circuitry 11 to generate and transmit a measurement signal to be emitted into the tank 5 by the propagation device 12. This signal can be time modulated, e.g. a pulsed signal (pulsed level gauging). Such a time modulated signal may be emitted using a high frequency carrier wave. Alternatively, the signal can be frequency modulated, e.g. a continuous signal with a frequency varying over a certain range (Frequency Modulated Continuous Wave, FMCW). The propagation device 12 acts as an adapter, enabling the signal generated in the transceiver circuitry 11 to propagate into the tank 5 as microwaves, and returning waves reflected by the surface 2 of the material 3.

In step S2, the reflected signal is received by the receiver 18 in the transceiver circuitry 11, where it is mixed (step S3) with a reference signal to form a measurement signal 29. The measurement signal 29 is A/D converted by converter 20 and is then provided to the processing circuitry 14.

The processing circuitry 14 finally determines a measurement result based on a relation between the emitted and received waves. In case of a time modulated signal (e.g. pulses), the distance to the surface 2 is determined based on the time of flight of the reflected signal. In case of a frequency modulated signal, the distance to the surface is determined based on a frequency shift of the reflected signal.

According to the present invention, it is not required to process the entire measurement signal, as the process variable of interest is only a detection when the level L enters a predetermined range. Therefore, in step S4, only a portion defining a predefined distance range of the tank is selected from the received signal, and this selected portion is processed in order to determine whether an echo is present in the predefined range.

This limited processing results in a discrete signal 30 which in step S5 is set to an active state (e.g. high level) if the selected portion includes information indicating a surface reflection (i.e. if the level in the tank has entered the predefined range). In step S6, this discrete signal 30 is communicated externally of the detector by means of the interface 16, preferably by a separate output terminal 6 (see FIG. 1).

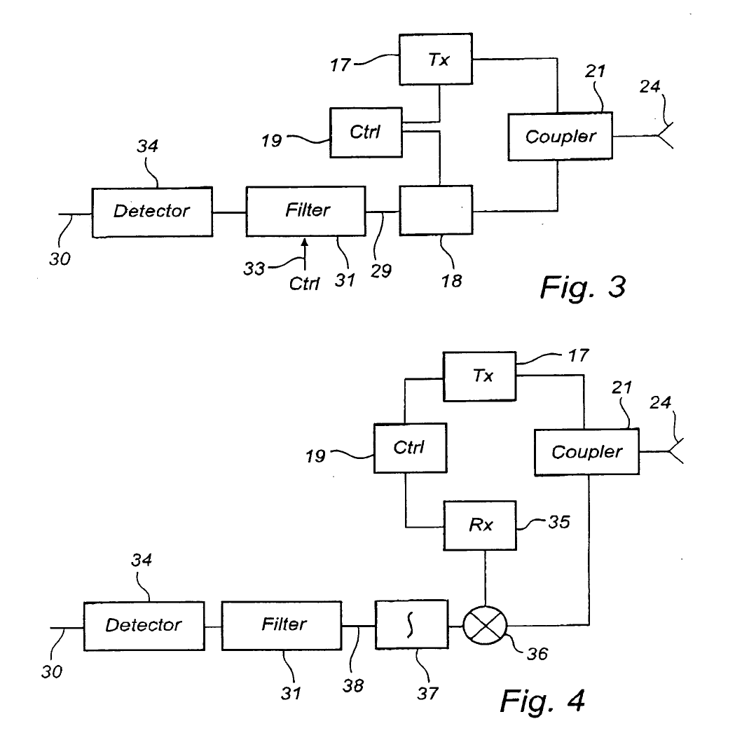

A further embodiment of the present invention is illustrated in FIG. 3, where elements similar to those in FIG. 2 are indicated by identical reference numerals. Here, the transceiver circuitry 11 is provided with a selector, e.g. an analogue filter 31, arranged to select a portion of the measurement signal. Selecting a portion of the measurement signal corresponds to selecting a portion of the reflection. The filter 31 can advantageously be provided with an input for receiving a control signal 33, defining the selected portion. The control signal 33 may in turn be received by the interface 28, thus allowing setting of the selected range externally of the detector 10.

In a time domain radar level detector, the filter 31 is suitably a time filter, adapted to select a time window of the measurement signal. In a frequency domain radar level detector, the filter 31 is suitably a frequency filter, e.g. a band pass filter, adapted to select a frequency band of the measurement signal.

In the illustrated embodiment, the filter 31 is analogue, and is adapted to receive the analogue measurement signal 29. Of course, also a digital filter may be employed, in which case the measurement signal will first have to be A/D-converted. The use of a digital filter may be advantageous, especially in the frequency domain.

Further, in this embodiment, the processing circuitry 14 in FIG. 2 can be reduced to a simple threshold detector 34, adapted to compare e.g. a power density or a maximum amplitude of the selected portion with a specified threshold. By a suitable selection of the threshold, such a comparison will detect if a surface echo is present in the distance range corresponding to the selected portion. If a surface echo is detected, the discrete signal 26 is set to active state.

In the illustrated embodiment, also the detector 34 is analogue, thus receiving an analogue signal from the filter 31. Therefore, the A/D-converter 20 in FIG. 2 is not required at all.

If a digital detector is employed, the filter output will need to be A/D-converted. Alternatively, if a digital filter is used, as described above, the output is of course already digital.

A particular case of the design in FIG. 3, adapted for pulsed radar level detection, is illustrated in FIG. 4, where again elements similar to those in FIGS. 2 and 3 are indicated by identical reference numerals.

Here, the receiver 18 comprises a second transmitter 35, a mixer 36, and an integrator (e.g. a sample and hold circuit) 37, The transmitter 17 is here adapted to transmit a pulse train with several thousand pulses during each measurement cycle (a pulse repetition frequency in the order of MHz). The second transmitter 35 is adapted to generate a similar pulse train, but with a slightly different frequency. The received reflection is combined (multiplied) with this second pulse train in the mixer 36, and integrated by integrator 37 to form a measurement signal 38. This signal 38 represents a time expansion of one pulse response from the tank. In a conventional time domain reflectometry radar level gauge, such a signal makes is possible to very precisely determine the time of flight, which typically is in the range of ns.

The measurement signal 38 is filtered by filter 31, and the selected portion is provided to the detector 34.

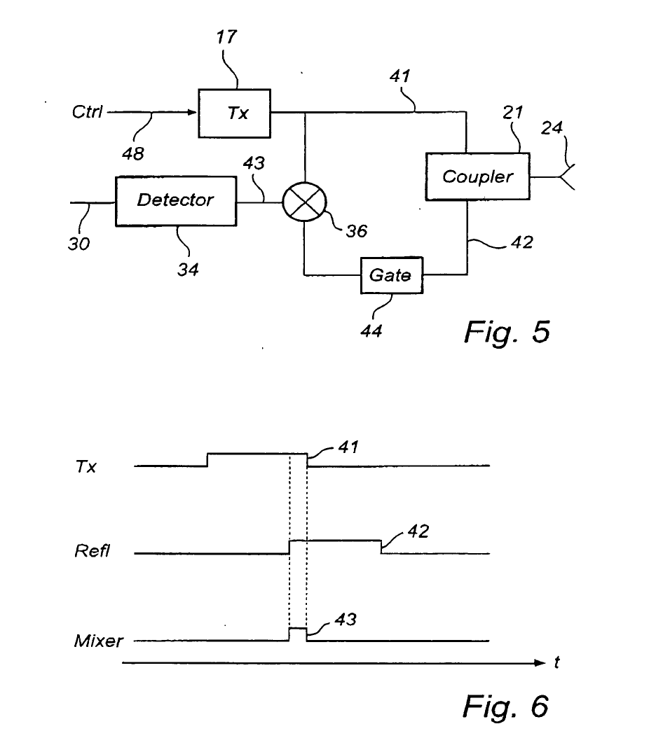

In an simplified version of the embodiment in FIG. 4, illustrated in FIG. 5, the transmitter 17 is instead arranged to transmit only one pulse per measurement cycle. The pulse is modulated by a carrier wave and allowed to propagate into the tank. The carrier modulated pulse 41 and its reflection 42 are then supplied to the mixer 36, which generates an output 43 only if both inputs are non-zero simultaneously. For example, the mixer 36 can be adapted to perform a multiplication of its two input signals. As illustrated in FIG. 6, this means that the mixer 36 will only provided an output 43 if the reflection 42 is returned within the duration of the transmitted pulse 41. If an output 43 is obtained from the mixer, this is thus an indication that the level has reached a level defined by the duration of the transmitted pulse 41.

In this case, no integrator nor filter is needed. The output 43 (mixer output) will itself be a selection of a portion of the reflection from the tank (determined by the duration of the transmitted pulse 41). The output 43 is provided to the detector 34, which in this case can be a very simple threshold detector, adapted to detect any signal above a specified threshold and in response to this detection set the discrete signal 30 to an active state.

In a practical implementation, using a free radiating antenna, a pulse duration of 2 ns would correspond to a detection range of approximately 30 cm from the antenna. Preferably, the microwave controller is further adapted to receive a control signal 48 for adjusting the pulse duration. The control signal 48 may be received by the interface 28, thus allowing setting of the selected range externally of the detector 10. A resolution of around 0.2 ns should be technically feasible, corresponding to a detection resolution of around 3 cm.

In case of disturbing reflections occurring in the near zone (close to the antenna) part of the reflection may be removed by a filter 44 arranged before the mixer.

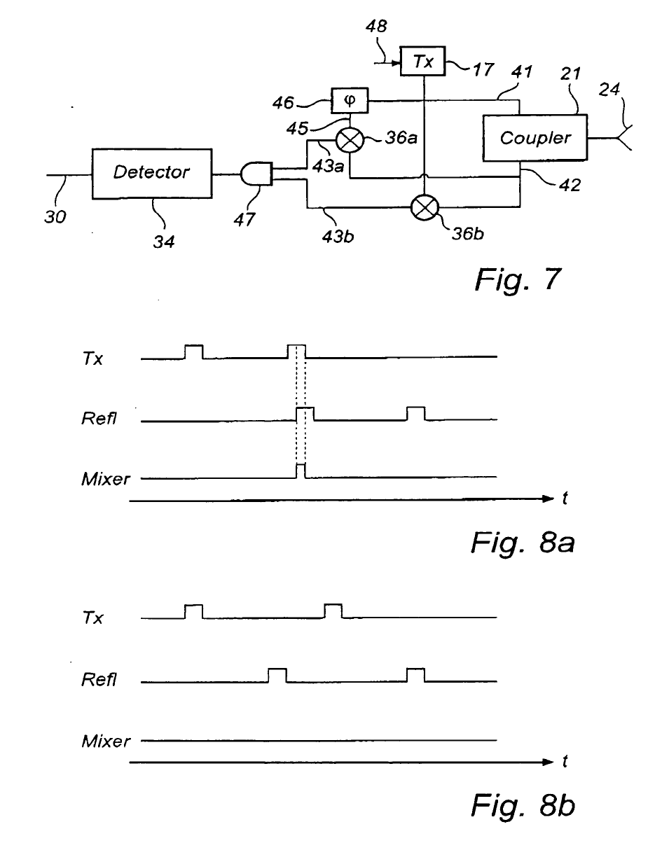

It is noted that the mixing of the transmitted pulse with its reflection may result in zero output if the phase of the reflection is 90 degrees shifted with respect to the transmitted signal. A solution to this problem is illustrated in FIG. 7, where the receiver is provided with two mixers 36a, 36b, which are provided with the transmitted pulse 41 and a transmitted pulse 45 which has been 90 degrees phase shifted by a filter 46, respectively. The outputs 43a, 43b from these mixers (typically referred to as in-phase component I and quadrature component Q) are then combined (e.g. added by an adder 47), thereby avoiding a zero output when the reflection is phase shifted by 90 degrees.

It is also clear from FIG. 6 that a detection in the range of interest will occur when the beginning of the reflected pulse 42 will coincide with the end of the transmitted pulse 41. It is thus in fact only the beginning and end of the transmitted pulse 41 that are relevant for the detection process. In practice, therefore, a single (long) transmission pulse may be replaced with two shorter pulses. This technique is known as staggered pulse repetition frequency, and the result is illustrated in figure 8a. Of course, a limitation with this solution is that the active detection range is limited to a range defined by the width of the latter pulse. If the surface rises above this limited detection range, the signal 30 will no longer be active. This is indicated in FIG. 8b.

The person skilled in the art realizes that the present invention by no means is limited to the preferred embodiments described above. On the contrary, many modifications and variations are possible within the scope of the appended claims. For example, the illustrated embodiments are not limited to transmitting, receiving and processing microwaves, but can instead be adapted for transmitting, receiving and processing e.g. laser signals. The choice of frequency range of the transmitted signals is basically only a question of selecting suitable components when realizing the described block diagrams.

Additionally, the preferred embodiments have been limited to one detection range. Of course, the invention is not limited to one range, but can include detection of several different distance ranges, possibly with several different output signals;

1. A radar level detector for detecting that a surface of a product in a tank has entered a predefined distance range in an upper half of said tank, said level detector comprising:
a transmitter for transmitting an electromagnetic transmission signal into the tank,
a propagation device for allowing said transmission signal to propagate towards said surface and for returning a reflection of said transmission signal from said surface,
a selector for selecting a portion of said reflection, said portion defining said predefined distance range,
a detector for setting a discrete signal to an active level if said portion includes information indicating a surface reflection, and
an interface for communicating said discrete signal externally of said level detector.

2. The radar level detector according to claim 1, wherein said distance range is an open range corresponding to a distance to said surface less than 5%.

3. The radar level detector according to claim 1, wherein said interface is a two-wire interface arranged to receive power to said detector.

4. The radar level detector according to claim 1, further comprising an internal power supply.

5. The radar level detector according to claim 1, further comprising an input device for receiving a signal adapted to adjust said selected portion.

6. The radar level detector according to claim 1, wherein said portion is a time window.

7. The radar level detector according to claim 1, wherein said portion is a frequency range.

8. The radar level detector according to claim 1, further comprising:
a mixer for generating a measurement signal by combining said reflection with said transmission signal, said measurement signal comprising information indicating a surface reflection,
wherein said selector is adapted to select a portion of said measurement signal.

9. The radar level detector according to claim 8, wherein said measurement signal is a time domain signal, and said portion is a time window.

10. The radar level detector according to claim 8, wherein said measurement signal is a frequency domain signal, and wherein said portion is a frequency range.

11. The radar level detector according to claim 8, wherein said frequency domain transmission signal has a bandwidth less than 250 MHz.

12. The radar level detector according to claim 8, wherein said frequency domain transmission signal has a frequency within a range belonging to the group consisting of 24-24.25 GHz, 5.725-5.875 GHz and 2.4-2.5 GHz.

13. The radar level detector according to claim 1, further comprising:
a mixer arranged to receive said transmission signal and said reflection, and to provide an output only if both said transmitted signal and said reflection are non-zero.

14. The radar level detector according to claim 13, wherein said transmission signal is a single time modulated pulse with a predefined pulse duration, so that said mixer output represents a time window of the reflected signal.

15. The radar level detector according to claim 14, further comprising an input terminal for receiving a signal adapted to adjust the pulse duration of said time modulated pulse.

16. The radar level detector according to claim 14, wherein said time modulated pulse is modulated by an introduction pulse and a termination pulse.

17. The radar level gauge according to claim 1, wherein said propagation device comprises at least one of a probe for guided wave transmission of said electromagnetic signal, an antenna for free propagation of said electromagnetic signal, and a hollow waveguide for guided propagation of said electromagnetic signal.

18. A radar level detector for detecting that a surface of a product in a tank has entered a predefined distance range in an upper half of said tank, said level detector comprising:
a transmitter for transmitting an electromagnetic transmission signal into the tank,
a propagation device for allowing said transmission signal to propagate towards said surface and for returning a reflection of said transmission signal from said surface,
a detector for detecting if a reflection of said transmission signal occurs within said predefined distance range, without continuously establishing a filling level of said tank, and
an interface for communicating a discrete output externally of said level detector, said discrete output indicating a result of said detection.

19. The radar level detector according to claim 18, wherein said distance range is an open range corresponding to a distance to said surface less than 5%.

20. The radar level detector according to claim 18, wherein said interface is a two-wire interface arranged to receive power to said detector.

21. The radar level detector according to claim 18, further comprising an internal power supply.

22. The radar level detector according to claim 18, wherein said detector comprises a mixer connected to said transmitter and adapted to receive said transmission signal and said reflection, and to provide an output only if both said transmission signal and said reflection are non-zero.

23. The radar level detector according to claim 9, wherein said transmission signal is a time modulated pulse with a predefined pulse duration, so that said mixer output represents a time window of the reflected signal.

24. The radar level detector according to claim 23, further comprising an input device for receiving a signal adapted to adjust the pulse duration of said time modulated pulse.

25. The radar level detector according to claim 23, wherein said time modulated pulse is modulated by an introduction pulse and a termination pulse.

26. The radar level detector according to claim 18, further comprising:
a mixer for generating a measurement signal by combining said reflected signal with said transmission signal, said measurement signal comprising information indicating a surface reflection, and
a selector for selecting a portion of said measurement signal.

27. The radar level detector according to claim 26, further comprising an input device for receiving a signal adapted to adjust said selected portion.

28. The radar level detector according to claim 26, wherein said measurement signal is a time domain signal, and said portion is a time window.

29. The radar level detector according to claim 26, wherein said measurement signal is a frequency domain signal, and wherein said portion is a frequency range.

30. The radar level detector according to claim 26, wherein said frequency domain transmission signal has a bandwidth less than 250 MHz.

31. The radar level detector according to claim 26, wherein said frequency domain transmission signal has a frequency within a range belonging to the group consisting of 24-24.25 GHz, 5.725-5.875 GHz and 2.4-2.5 GHz.

32. The radar level detector according to claim 31, wherein said propagation device comprises at least one of a probe for guided wave transmission of said electromagnetic signal, an antenna for free propagation of said electromagnetic signal, and a hollow waveguide for guided propagation of said electromagnetic signal.

33. A radar level detection method for detecting that a surface of a product in a tank has entered a predefined distance range in an upper half of said tank, comprising:
transmitting an electromagnetic transmission signal into the tank,
allowing said transmission signal to propagate towards said surface,
receiving a reflection of said transmission signal from said surface,
selecting a portion of said reflection, said portion defining said predefined distance range,
setting a discrete signal to an active level if said portion includes information indicating a surface reflection, and
communicating said discrete signal externally of said level detector.

34. The method according to claim 33, wherein said distance range is an open range corresponding to a distance to said surface less than 5%.

35. The method according to claim 33, wherein said selecting comprises selecting a time window.

36. The method according to claim 33, wherein said selecting comprises selecting a frequency band.

37. The method according to claim 33, further comprising adjusting said selected portion in dependence of a desired detection range.

38. The method according to claim 33, further comprising generating a measurement signal by combining said reflected signal with said transmission signal, said measurement signal comprising information indicating a surface reflection,
wherein said selected portion is selected by selecting a portion of said measurement signal.

39. The method according to claim 33, further comprising combining said transmission signal and said reflection, and providing an output only if both said transmitted pulse and said reflected pulse are non-zero.

40. The method according to claim 39, wherein said transmission signal is a single time modulated pulse with a predefined pulse duration, so that said output represents a time window of the reflected signal.

41. The method according to claim 40, further comprising adjusting the pulse duration of said transmission pulse in dependence of a desired detection range.

42. A radar level detection method for detecting that a surface of a product in a tank has entered a predefined distance range in an upper half of said tank, comprising:
transmitting an electromagnetic transmission signal into the tank,
allowing said transmission signal to propagate towards said surface,
receiving a reflection of said transmission signal from said surface,
detecting if a reflection of said transmission signal occurs within said predefined distance range, without continuously establishing a filling level of said tank, and
communicating a discrete output externally of said level detector, said discrete output indicating a result of said detection.

43. The method according to claim 42, wherein said distance range is an open range corresponding to a distance to said surface less than 5%.

44. The method according to claim 42, further comprising receiving said transmission signal and said reflection, and providing an output only if both said transmission signal and said reflection are non-zero.

45. The method according to claim 42, wherein said transmission signal is a single time modulated pulse with a predefined pulse duration, so that said output represents a time window of the reflected signal.

46. The method according to claim 43, further comprising adjusting the pulse duration of said transmission pulse in dependence of a desired detection range.

47. The method according to claim 42, further comprising
generating a measurement signal by combining said reflected signal with said transmission signal, said measurement signal comprising information indicating a surface reflection, and
selecting a portion of said measurement signal.

48. The method according to claim 47, wherein said selecting comprises selecting a time window.

49. The method according to claim 47, wherein said selecting comprises selecting a frequency band.

50. The method according to claim 47, further comprising adjusting said selected portion in dependence of a desired detection range.

101-128. (canceled)
